(19) United States
(12) Patent Application Publication
(10) Pub. No.: US 2013/0093786 A1
(43) Pub. Date: Apr. 18, 2013

(54) VIDEO THUMBNAIL DISPLAY DEVICE AND VIDEO THUMBNAIL DISPLAY METHOD

(71) Applicants: Naohisa Tanabe, Osaka (JP); Toshiyuki Ishioka, Osaka (JP)

(72) Inventors: Naohisa Tanabe, Osaka (JP); Toshiyuki Ishioka, Osaka (JP)

(21) Appl. No.: 13/698,693

(22) PCT Filed: Mar. 2, 2012
(86) PCT No.: PCT/JP2012/001454

§ 371 Date: Nov. 19, 2012

(30) Foreign Application Priority Data
Apr. 8, 2011 (JP) 2011-086331

(51) Int. Cl. G09G 5/00

(52) U.S. Cl. 345/619

(57) ABSTRACT

A video thumbnail display device includes a receiving unit which receives a selection of the first template included in the first thumbnail, a template determining unit which determines whether or not the second thumbnail including the second template which includes the same video data as that in the first template is displayed, an image obtaining unit which obtains the first display image in the first thumbnail and the second display image in the second thumbnail when the second thumbnail is determined to be displayed; a plural-video displaying unit which displays the first template in the first display region and the second template in the second display region, and an image displaying unit which displays the first display image in the region associated with the first display region and the second display image in the region associated with the second display region.

### TECHNICAL FIELD

The present invention relates to a video thumbnail display device which displays, as a thumbnail, a video which includes a template including predetermined video data and a still image to be displayed in the template, and a video thumbnail display method.

### BACKGROUND ART

In recent years, along with the popularization of digital cameras and digital camcorders, opportunities to shoot video and photographs are increasing. Moreover, devices for processing the shot video and photographs for entertainment have appeared in the market. An example of such devices is capable of combining the photographs with a template including predetermined video data such as a desired animated template (referring to an original video having a frame for embedding the photographs into animation effect) and storing the resulting video in a hard disc as a video work.

The video work stored in the device can be personally appreciated, or recorded on media such as a DVD so as to be provided to the third party. Moreover, in the case where the number of video works stored in the device has increased, it is possible to search for a desired video work through a thumbnail list display screen in which a list of thumbnails (hereinafter referred to as video thumbnails) representing the video works is displayed.

However, for example, when plural video works using the same animated template are displayed in the thumbnail list display screen, the front image of the animated template is mostly displayed as thumbnail images which are obtained by capturing the front images of the video works. Consequently, the video works using the same animated template are hardly distinguishable only from the thumbnail images because the differences are only in the photographs used in the content.

In such a case, although it is possible to distinguish the video works by repeating reproduction in video thumbnails or in full-screen one by one and remembering the animation effects and the photographs used therein for all the video works, it takes time to find the desired video work.

In this regard, if plural video thumbnails can be simultaneously reproduced and the animation effects and the photographs used therein can be compared, the desired video work will easily be found.

Thus, as a method to simultaneously reproduce video thumbnails, a technique has been disclosed which simultaneously activates plural video thumbnails by providing plural video decoder in a device in order to enable simultaneous decoding of plural videos (refer to Patent Literature (PTL) 1 and 2, for example).

Moreover, as another method, a technique has been disclosed which makes plural video thumbnails look like being simultaneously activated by using one video decoder by time-sharing (refer to Patent Literature (PTL) 3 and 4, for example).

Furthermore, a technique has been disclosed which prepares for plural thumbnail images for one video and displays the plural thumbnails as indexes for allowing characteristics of the video work to be perceived at a glance, rather than simultaneously reproducing plural video thumbnails (refer to Patent Literature (PTL) 5 to 8, for example).

### CITATION LIST

### Patent Literature

[PTL 1] Japanese Unexamined Patent Application Publication No. 2006-140564
[PTL 2] Japanese Unexamined Patent Application Publication No. 2009-20266
[PTL 3] Japanese Unexamined Patent Application Publication No. 2008-72336
[PTL 4] Japanese Unexamined Patent Application Publication No. 2010-206486
[PTL 5] Japanese Unexamined Patent Application Publication No. 2001-76460
[PTL 6] Japanese Unexamined Patent Application Publication No. 2009-284527
[PTL 7] Japanese Unexamined Patent Application Publication No. 2003-319295
[PTL 8] Japanese Unexamined Patent Application Publication No. 2010-213136

### SUMMARY OF INVENTION

### Technical Problem

However, the technique disclosed in the above PTL 1 and 2 requires having plural video decoders, resulting in a complicated configuration. Moreover, it is undesirable in consideration of application to embedded devices because of increase in costs.

Moreover, in the technique disclosed in the above PTL 3 and 4, since the video decoder is used by time-sharing, there is a high possibility of deterioration in reproduction quality of the video thumbnail, for example, due to unsmooth movements in the video. Furthermore, complicated software control is required for using the video decoder by time-sharing.

Furthermore, in the technique disclosed in the above PTL 5 to 8, plural still thumbnail images are prepared for one video and are displayed as indexes for allowing characteristics of the video work to be perceived at a glance, however, thumbnail images including only still images are not preferable because matching of a moving animation effect with photographs used therein is also important.

As described above, the conventional techniques have problems in that, in selecting a desired video from a screen in which plural video thumbnails using the templates including the same video data such as the animated template are displayed, a complicated configuration is required and reproduction quality of the video thumbnail may deteriorate.

The present invention was conceived in view of the above-described problems and has as an object to provide a video thumbnail display device and a video thumbnail display method by which a desired video can be selected, with a simple configuration, from a screen displaying plural video thumbnails that use templates including the same video data while suppressing deterioration in reproduction quality of the video thumbnails.

### Solution to Problem

In order to solve the above-described problems, the video thumbnail display device according to the present invention is a video thumbnail display device which displays, on a screen, a list of thumbnails representing videos, each of the videos including a video template that is a template including predetermined video data and a display image that is a still image displayed in an image display region in the video template, the video thumbnail display device includes: a receiving unit which receives a selection of a first template that is a video template included in a video represented by a first thumbnail among the thumbnails displayed on the screen, a template determining unit which determines whether or not a second thumbnail is displayed on the screen, the second thumbnail being a thumbnail representing a video including a second template which includes the same video data as that in the first template; an image obtaining unit which obtains a first display image and a second display image in the case where the second thumbnail is determined to be displayed, the first display image being a display image included in the video represented by the first thumbnail, and the second display image being a display image included in the video represented by the second thumbnail; a plural-video displaying unit which displays the first template in a first display region on the screen in which the first thumbnail is displayed and to display the second template in a second display region on the screen in which the second thumbnail is displayed; and an image displaying unit which displays the first display image in a region associated with the first display region and to display the second display image in a region associated with the second display region.

Accordingly, the first template is displayed in the first display region in which the first thumbnail is displayed and the first display image is displayed in the region associated with the first display region on the screen, while the second template is displayed in the second display region in which the second thumbnail is displayed and the second display image is displayed in the region associated with the second display region on the screen. Here, the first template and the second template include the same video data. Accordingly, it is possible to decode the same video data using one video decoder, which enables the first template and the second template to be decoded without deterioration in reproduction quality, with a simple configuration. Moreover, the first display image and the second display image are displayed in the respective regions in the same screen, so that a desired video can be easily selected. With this, with a simple configuration, the desired video can be selected from the screen displaying plural video thumbnails that use templates including the same video data while suppressing deterioration in reproduction quality of the video thumbnails.

Furthermore, it is preferable that the image displaying unit displays the first display image when an image display region in the first template is displayed, and to display the second display image when an image display region in the second template is displayed.

Accordingly, the respective display images are displayed when a corresponding image display region is displayed in the video template. With this, the video templates and the display images can be matched in the video thumbnails, so that the desired video can be easily selected from the screen which displays plural video thumbnails that use the templates including the same video data.

Furthermore, it is preferable that the image obtaining unit selects display images, from among display images to be displayed in image display regions included in the video, in descending order of importance of the image display regions or importance of the display images, to obtain the selected display images as the first display image and the second display image.

Accordingly, the display images are selected in descending order of importance of the image display regions or importance of the display images. With this, since the display images are selected in descending order of importance of the image display regions or importance of the display images in the case where a number of display images exist, it is possible to reduce processing load in decoding the display images while suppressing deterioration in the reproduction quality of the video thumbnails.

Furthermore, it is preferable that the image obtaining unit selects display images that are associated with the image display regions in descending order of importance of the image display regions which is determined according to at least one of a display position, a size and a display period of each of the image display regions, to obtain the selected display images as the first display image and the second display image.

Accordingly, the display images are selected in descending order of importance of the image display regions which is determined according to at least one of the display position, the size and the display period of each of the image display regions. That is, since the degree of importance of the image display region can be determined according to at least one of the display position, the size and the display period of each of the image display regions, the display images can be selected with an easy process.

Furthermore, it is preferable that the image obtaining unit selects display images in such a manner that the number of display images is smaller as an available memory capacity is smaller, to obtain the selected display images as the first display image and the second display image.

Accordingly, the display images are selected in such a manner that the number of display images is smaller as an available memory capacity is smaller. With this, in the case where the available memory capacity is small, the number of display images needed to be decoded is reduced, thereby reducing processing load in decoding the display images.

Furthermore, it is preferable that the video thumbnail display device further includes an image decoding unit which decodes coded image data of the display image, in which the image displaying unit selects display images that are decodable by the image decoding unit in display time intervals between display images included in one of the videos represented by the thumbnails, to obtain the selected display images as the first display image and the second display image.

Accordingly, the display images that are decodable by the image decoding unit within the display time intervals between display images are selected. With this, by decoding the display images in the time intervals, more display images can be selected even in the case where only a limited memory capacity is available. Moreover, by decoding only the display images decodable in the time intervals, deterioration in reproduction quality of the video thumbnails caused by a delay in decoding can be prevented.

Furthermore, it is preferable that the image obtaining unit obtains the first display image and the second display image with reference to template managing information and image managing information, the video template being associated with an identifier for identifying the display image to be displayed in the image display region in the video template in the template managing information, and the identifier being associated with information about the display image identified by the identifier in the image managing information.

Accordingly, the display image is obtained with reference to the template managing information in which the video template and the identifier for the display image are associated, and the image managing information in which the identifier and information about the display image are associated. With this, by using the template managing information and the image managing information, the display image can be selected with an easy process.

Furthermore, it is preferable that the video thumbnail display device further includes a communication unit which obtains video data included in the video template, image data of the display image, the template managing information, and the image managing information via a communication network.

Accordingly, the video data, the image data, the template managing information, and the image managing information are obtained via the communication network. With this, the data and the information can be obtained from the external device even without the storing unit in which the data and the information is stored.

The present invention can be implemented not only as such a video thumbnail display device, but also as a video thumbnail display method having the steps corresponding to the operations performed by the characteristic constituent units of the video thumbnail display device. Furthermore, the present invention can be implemented as a program causing a computer to execute these steps of the video thumbnail display method. Such a program can naturally be distributed through recording media such as CD-ROMs or via communication media such as the Internet. Furthermore, the present invention can be implemented as an integrated circuit having the characteristic constituent units of the video thumbnail display device.

### Advantageous Effects of Invention

According to the video thumbnail display device in the present invention, with a simple configuration, a desired video can be selected from a screen displaying plural video thumbnails that use a template including the same video data while suppressing deterioration in reproduction quality of the video thumbnails.

### BRIEF DESCRIPTION OF DRAWINGS

FIG. 1 is a block diagram showing a functional configuration of a video thumbnail display device according to Embodiment 1 of the present invention.

FIG. 2 is a diagram showing examples of created video data, template video data, and image data.

FIG. 3 is a diagram showing an example of template managing information according to Embodiment 1 of the present invention.

FIG. 4 is a diagram showing an example of image managing information according to Embodiment 1 of the present invention.

FIG. 5 is a diagram showing an example of device-specific information according to Embodiment 1 of the present invention.

FIG. 6 is a flowchart showing an example of operations of the video thumbnail display device in displaying a thumbnail list display screen on a monitor according to Embodiment 1 of the present invention.

FIG. 7 is a diagram showing an example of the thumbnail list display screen on the monitor according to Embodiment 1 of the present invention.

FIG. 8 is a diagram showing an example of the thumbnail list display screen in which images are superimposed on video templates by an image displaying unit according to Embodiment 1 of the present invention.

FIG. 9 is a flowchart showing an example of processing of an image obtaining unit for obtaining a first display image and a second display image according to Embodiment 1 of the present invention.

FIG. 10 is a diagram illustrating that display images are selected by the image obtaining unit based on the degree of importance of image display regions or of the display images according to Embodiment 1 of the present invention.

FIG. 11 is a diagram illustrating that the display images are selected by the image obtaining unit based on the degree of importance of the image display regions or of the display images according to Embodiment 1 of the present invention.

FIG. 12 is a diagram illustrating that the image obtaining unit selects an image decodable in a display time interval between display images according to a variation of Embodiment 1 of the present invention.

FIG. 13 is a block diagram showing a functional configuration of a video thumbnail display device according to Embodiment 2 of the present invention.

FIG. 14 is a block diagram showing a minimum configuration of the video thumbnail display device.

### DESCRIPTION OF EMBODIMENTS

The following describes embodiments of the present invention with reference to the drawings.

### Embodiment 1

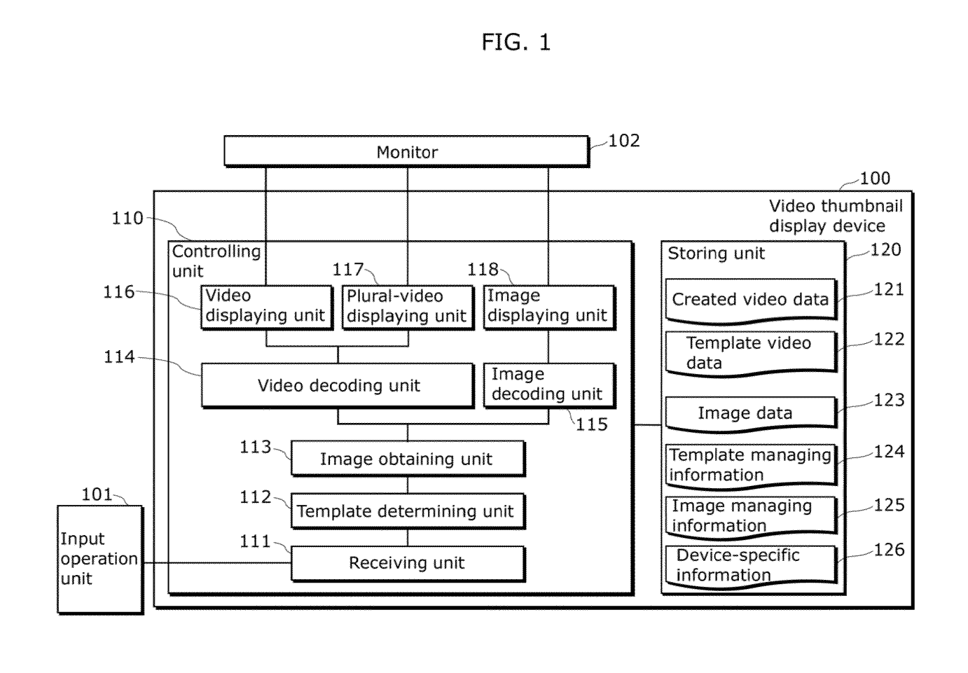

FIG. 1 is a block diagram showing a functional configuration of a video thumbnail display device 100 according to Embodiment 1 of the present invention.

The video thumbnail display device 100 displays a list of thumbnails representing videos on a display, and each of the videos includes a video template that is a template including predetermined video data and a display image that is a still image to be displayed in an image display region in the video template. It is to be noted that the video template may include any video data, but hereinafter, it is described as an animated template including an animation. Moreover, a thumbnail refers to an image showing a scene in the video in a reduced size.

Specifically, as shown in the diagram, the video thumbnail display device 100 includes a controlling unit 110 and a storing unit 120. Moreover, as external connection devices for the video thumbnail display device 100, an input operation unit 101 and a monitor 102 are provided. The controlling unit 110 receives an input of an operation from a user through the input operation unit 101 and causes the monitor 102 to display the list of the thumbnails using information stored in the storing unit 120.

In other words, the user uses the input operation unit 101 such as a remote controller and a touch panel to operate the video thumbnail display device 100. Moreover, the result of the operation by the user is outputted to the monitor 102 such as a television and a touch panel. Furthermore, as examples of the video thumbnail display device 100, devices such as a television, an HDD recorder, and a residential server are assumed.

Here, as shown in the diagram, the controlling unit 110 includes a receiving unit 111, a template determining unit 112, an image obtaining unit 113, a video decoding unit 114, an image decoding unit 115, a video displaying unit 116, a plural-video displaying unit 117, and an image displaying unit 118.

The receiving unit 111 receives operation information (such as operation information through a remote controller and a touch panel) inputted to the input operation unit 101 when the user perform operations on the thumbnail list display screen that is a screen on which the list of the thumbnails are displayed. Specifically, the receiving unit 111 receives a selection of a first template that is a video template included in a video represented by a first thumbnail among the thumbnails displayed on the monitor 102.

The template determining unit 112 determines whether or not a second thumbnail that is a thumbnail representing a video including a second template which includes the same video data as that in the first template is displayed. Specifically, the template determining unit 112 determines whether or not there exists a video that uses the same animated template as that in the video currently indicated by a cursor in the thumbnail list display screen based on the operation information received by the receiving unit 111 and internal information regarding the thumbnail list display screen.

In the case where the template determining unit 112 determines that the second thumbnail is displayed, the image obtaining unit 113 obtains a first display image that is an image included in the video represented by the first thumbnail and a second display image that is an image included in the video represented by the second thumbnail. In other words, in the case where the template determining unit 112 determines that the video using the same animated template exists, the image obtaining unit 113 reads out information on an image to be displayed in a video thumbnail with reference to template managing information 124 and image managing information 125 described below.

Specifically, the image obtaining unit 113 obtains a photograph identifier used in the animated template based on the type of the same animated template and the template managing information 124, and reads out, based on the image managing information 125, information on the image (such as the file name of the image) to be displayed in the video thumbnail.

The video decoding unit 114 decodes coded video data. In other words, the video decoding unit 114 decodes the video data included in the video template. It is to be noted that, as a compression scheme for the video data, formats such as MPEG-2 and H.264 are available.

The image decoding unit 115 decodes coded image data. In other words, the image decoding unit 115 decodes the image data of the display image displayed in the video template. It is to be noted that, as a compression scheme for the image data, formats such as JPEG and PNG are available.

The video displaying unit 116 displays the data decoded by the video decoding unit 114 on the monitor 102. That is, when the video template which includes the same video data as that in the first template is not displayed on the monitor 102, the video displaying unit 116 displays the first template in the first display region in which the first thumbnail is displayed on the monitor 102.

The plural-video displaying unit 117 displays the data decoded by the video decoding unit 114 at plural positions where thumbnails are displayed on the monitor 102. That is, in the case where the first template and second template are displayed on the monitor 102, the plural-video displaying unit 117 displays the first template in the first display region in which the first thumbnail is displayed on the monitor 102, while displaying the second template in the second display region in which the second thumbnail is displayed on the monitor 102. This function enables plural video thumbnails to be simultaneously reproduced based on one video data item.

The image displaying unit 118 displays the data decoded by the image decoding unit 115 along with the video template displayed by the plural-video displaying unit 117 on the monitor 102. In other words, the image displaying unit 118 displays the first display image in the region associated with the first display region, and the second display image in the region associated with the second display region.

It is to be noted that the video thumbnail display device 100 holds information such as information about the currently displayed thumbnail image and the cursor position.

Moreover, the storing unit 120 is a storing medium such as a hard disc in which information for the controlling unit 110 causing the monitor 102 to display the list of the thumbnails is stored. Specifically, in the storing unit 120, created video data 121, template video data 122, image data 123, the template managing information 124, the image managing information 125, and device-specific information 126 are stored. The details will be described below.

With the configuration of the video thumbnail display device 100 according to the present invention as described above, in the case where plural animated templates including the same video data exists, the plural animated templates are simultaneously reproduced and the corresponding image data items are displayed in the image display regions in the animated templates.

Next, details of the created video data 121, the template video data 122, and the image data 123 stored in the storing unit 120 will be described.

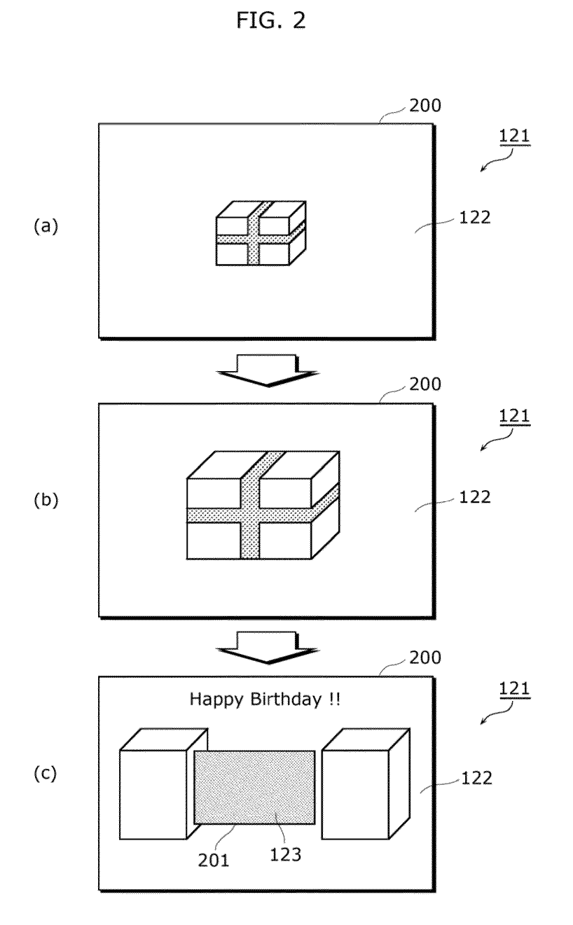

FIG. 2 is a diagram showing examples of the created video data 121, the template video data 122, and the image data 123 according to Embodiment 1 of the present invention.

First, details of the animated template will be described. Shown in (a) to (c) in FIG. 2 are animated template displays 200. In addition, the image display region 201 in (c) in FIG. 2 shows an (empty) photograph frame in which an arbitrary photograph is embeddable. It is to be noted that although the image display region 201 is assumed to be a photograph frame in the description below, it is not limited to the photograph frame, and it is sufficient that the image display region 201 is a region for displaying a still image. Moreover, although the image displayed in the image display region 201 is assumed to be a photograph in the description below, it is not limited to the photograph, and it is sufficient that the image is a still image.

For example, description is given in the case where the theme of the animated template is “birthday”. When the animated template for “birthday” is started, a present box is displayed in a relatively small size as shown in (a) in FIG. 2, and then the present box is gradually enlarged by an animation effect as shown in (b) in FIG. 2. Subsequently, as shown in (c) in FIG. 2, the present box is divided into two parts and the image display region 201 that is the photograph frame appears from the box, for example.

This example is an extract from the animated template, and a common animated template is a combination of various effects and photograph frames and usually the length of the animated template is approximately for several minutes. The animated template according to the present invention is becoming relatively easy to create by use of techniques such as Flash™. Thus, the user embeds a desired photograph, or the device embeds an automatically selected photograph in the image display region 201 shown in (c) in FIG. 2, so that different video works can be created using one animated template.

Accordingly, combination of the photograph and the animated template can provide the user with an entertainment that is more than just viewing the photograph only.

The video data included in the animated template is referred to as the template video data 122. The video data that has been processed to be a video work by embedding a still image in the image display region 201 in the animated template is referred to as the created video data 121. The still image data used for creating the created video data 121 is referred to as the image data 123.

Moreover, managing information for managing the created video data 121 and the template video data 122 is referred to as the template managing information 124, and information for managing the image data 123 is referred to as the image managing information 125.

Next, details of the template managing information 124 and the image managing information 125 stored in the storing unit 120, and the device-specific information 126 are described.

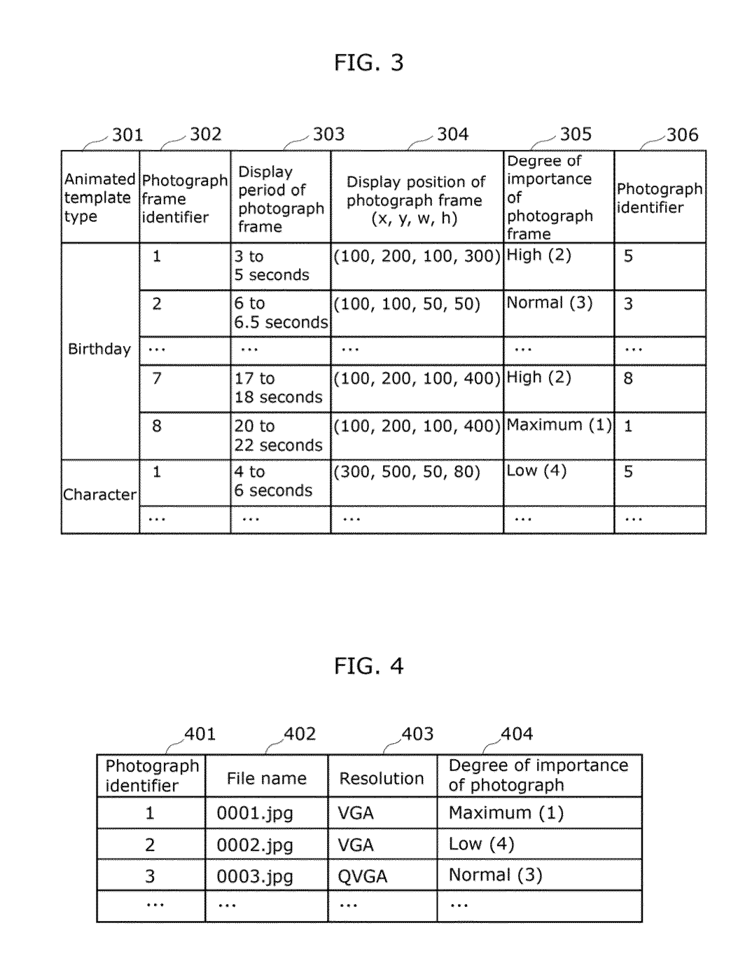

FIG. 3 is a diagram showing an example of the template managing information 124 according to Embodiment 1 of the present invention.

The template managing information 124 is a set of information for managing the created video data 121 and the template video data 122. Specifically, as shown in the diagram, the template managing information 124 is a set of information in which an animated template type 301, a photograph frame identifier 302, a display period of photograph frame 303, a display position of photograph frame 304, degree of importance of photograph frame 305 and a photograph identifier 306 are associated.

The animated template type 301 indicates types of the animated templates which are the video templates. Examples of the animated templates include “birthday”, “sports day”, “character” and others. Depending on the animated template type 301, the animation effects and configuration of the photograph frames vary.

For example, in the case where the animated template type 301 is “birthday”, the animation effect and the configuration of the photograph frame may be as the above described (a) to (c) in FIG. 2. Dozens of animated templates are usually prepared in the device, and new animated templates can also be downloaded via networks and utilized.

The photograph frame identifier 302 is an identification number for uniquely determining a photograph frame in an animated template. That is, the photograph frame identifier 302 is an identifier for identifying the image display region 201 shown in (c) in FIG. 2.

The display period of photograph frame 303 indicates a time period in which the photograph frame in the animated template is displayed.

The display position of photograph frame 304 indicates a position in which the photograph frame is displayed and the size of the photograph frame in the animated template. Moreover, in the case where the photograph frame is inclined, information on the incline can also be stored in the display position of photograph frame 304.

The degree of importance of photograph frame 305 indicates the degree of importance of the photograph frame in the animated template. As the degree of importance, values such as maximum (1), high (2), normal (3) low (4), and minimum (5) can be assigned in descending order of importance. For example, the maximum degree of importance (1) is assigned to a photograph frame that is important in terms of the animation effect as shown in the image display region 201 in (c) in FIG. 2. On the other hand, the low degree of importance (4) is assigned to a photograph frame that is less important in terms of the animation effect, or a small photograph frame.

Moreover, although the degree of importance of photograph frame 305 is assumed to be predetermined for each animated template type, the user may set or change the degree of importance. Furthermore, as described below, it is also possible to decode and display only important photographs in a superimposed manner utilizing the degree of importance of photograph frame 305 when all photographs cannot be displayed in a superimposed manner.

The photograph identifier 306 indicates an identifier for identifying a photograph embedded in the photograph frame in the animated template. It is to be noted that the photograph identifier 306 is determined at the time when the created video data 121 is created.

FIG. 4 is a diagram showing an example of the image managing information 125 according to Embodiment 1 of the present invention.

The image managing information 125 is a set of information for managing the image data 123. Specifically, as shown in the diagram, the image managing information 125 is a set of information in which a photograph identifier 401, a file name 402, resolution 403, and degree of importance of photograph 404 are associated.

The photograph identifier 401 is identification information for uniquely determining a photograph. The photograph identifier 401 is associated with the photograph identifier 306 in the template managing information 124 shown in FIG. 3.

The file name 402 indicates the name of the image file of the photograph indicated by the photograph identifier 401. Moreover, the resolution 403 indicates resolution information of the photograph.

The degree of importance of photograph 404 indicates the degree of importance of the photograph. Details of the degree of importance are omitted because the description is shared with the degree of importance of photograph frame 305 shown in FIG. 3. It is to be noted that since a photograph having a high degree of importance is usually embedded in a photograph frame having a high degree of importance in the animated template, the degree of importance of photograph 404 may be set in association with the degree of importance of photograph frame 305, however, it is not necessarily needed.

Moreover, degree of importance of photograph 404 may be automatically assigned by the video thumbnail display device 100 using techniques such as image analysis. Furthermore, the user may set or change the degree of importance of photograph 404.

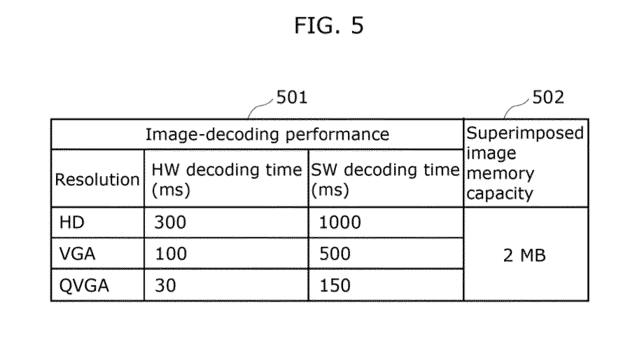

FIG. 5 is a diagram showing an example of the device-specific information 126 according to Embodiment 1 of the present invention.

The device-specific information 126 is a set of unique information about the video thumbnail display device 100. Specifically, as shown in the diagram, the device-specific information 126 is a set of information in which image-decoding performance 501 and super imposed image memory capacity 502 are associated.

The image-decoding performance 501 indicates the resolution of an image data to be decoded and decoding time corresponding to the resolution. It is to be noted that HW decoding time indicates processing time in the case where decoding is performed using hardware, and SW decoding time indicates processing time in the case where decoding is performed using software.

The super imposed image memory capacity 502 indicates a memory capacity usable for decoding the image data. That is, the smaller the super imposed image memory capacity 502 is, the smaller the number of decodable images is.

Next, processing of the video thumbnail display device 100 to display the thumbnail list display screen on the monitor 102 will be described.

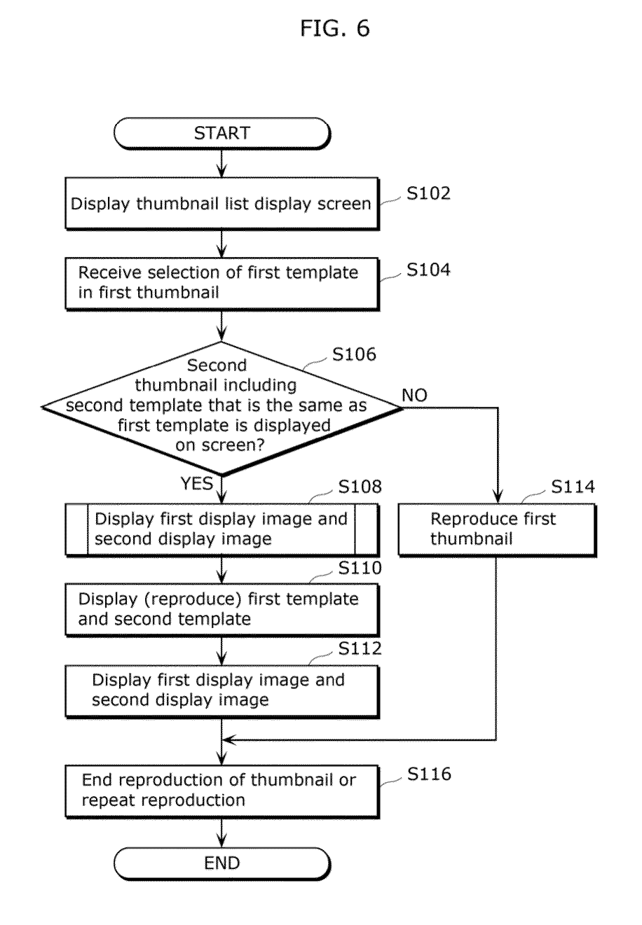

FIG. 6 is a flowchart showing an example of operations of the video thumbnail display device 100 to display the thumbnail list display screen on the monitor 102 according to Embodiment 1 of the present invention.

First, it is assumed that the created video data 121, the template video data 122, the image data 123, the template managing information 124, and the image managing information 125 are stored in the storing unit 120 of the video thumbnail display device 100, and the video thumbnail display device 100 is activated. Moreover, it is assumed that plural videos using the same animated template are accumulated as items of created video data 121.

First, as shown in the diagram, when desiring to view a video work, the user operates the input operation unit 101 for example, so that the thumbnail list display screen is displayed on the monitor 102 (S102). In the thumbnail list display screen, plural thumbnail images are displayed. Thus, the user can operate the video thumbnail display device 100 through the thumbnail list display screen on the monitor 102.

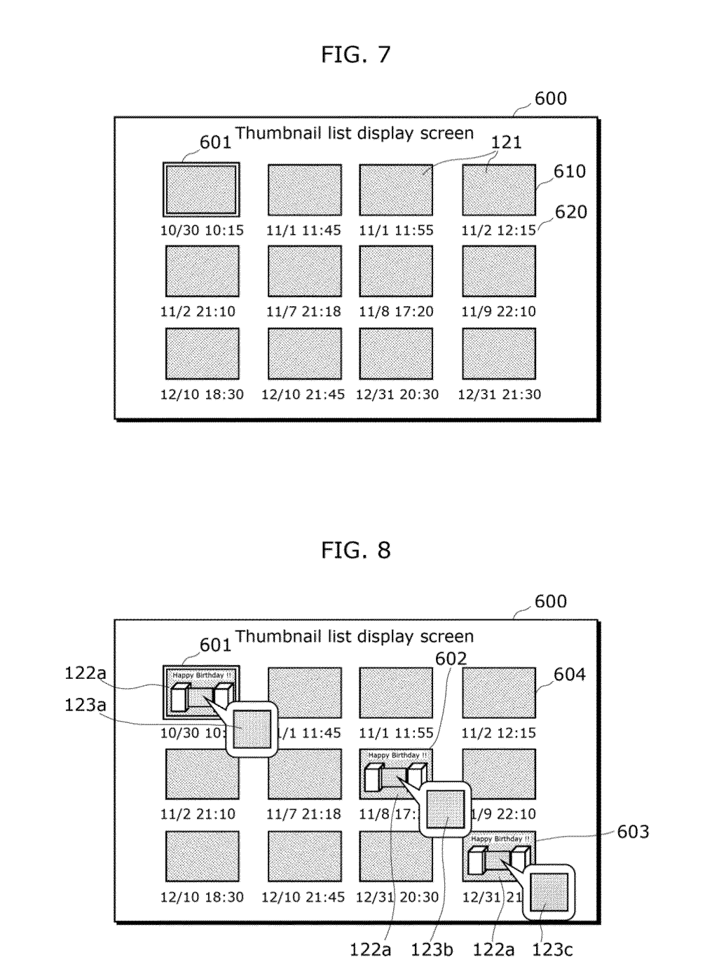

FIG. 7 is a diagram showing an example of the thumbnail list display screen 600 displayed on the monitor 102 according to Embodiment 1 of the present invention.

As shown in the diagram, in the thumbnail list display screen 600, a list of all the items of created video data 121 is displayed as thumbnail images 610. A video can be reproduced in a reduced size by the user placing a cursor over a corresponding thumbnail image 610 via the input operation unit 101.

When the thumbnail image 610 is not pointed by the cursor, the front image or an image of a representative scene in the created video data 121 is displayed as the thumbnail image 610. Moreover, supplemental information 620 including information about date and time of creation of the created video data 121 is displayed below the thumbnail image 610, for example.

Next, turning back to FIG. 6, the receiving unit 111 receives a selection of the first template which is the video template included in the video represented by the first thumbnail among the thumbnails displayed on the monitor 102 (S104). For example, as shown in FIG. 7, the user selects the thumbnail image 601 at the upper left corner with the cursor, so that the receiving unit 111 receives the selection of the first template.

Subsequently, the template determining unit 112 determines whether or not the second thumbnail that is the thumbnail representing the video including the second template which includes the same video data as that in the first template (S106). That is, the template determining unit 112 determines whether or not the created video data 121 using the same animated template exists in the thumbnail list display screen 600.

In the case where the template determining unit 112 determines that the second thumbnail is displayed on the monitor 102 (YES in S106), the image obtaining unit 113 obtains the first display image that is the display image included in the video represented by the first thumbnail and the second display image that is the display image included in the video represented by the second thumbnail (S108).

Specifically, the image obtaining unit 113 determines an image to be superimposed on the animated template using the photograph identifier 306 in the template managing information 124, and the photograph identifier 401 and the file name 402 in the image managing information 125, and decodes the image to be superimposed. It is to be noted that the image to be superimposed may be decoded and stored in the storing unit 120 in advance. Details of processing by which the image obtaining unit 113 obtains the first display image and the second display image will be described below.

The plural-video displaying unit 117 displays the first template in the first display region in which the first thumbnail is displayed on the monitor 102, and the second template in the second display region in which the second thumbnail is displayed on the monitor 102 (S110).

Specifically, the video decoding unit 114 decodes the template video data 122, and the plural-video displaying unit 117 displays the resulting data items at the corresponding thumbnail positions.

The image displaying unit 118 displays the first display image in the region associated with the first display region on the monitor 102, and the second display image in the region associated with the second display region on the monitor 102 (S102). Specifically, the image displaying unit 118 displays the first display image when the image display region is displayed in the first template, and the second display image when the image display region is displayed in the second template.

More specifically, the image displaying unit 118 displays the selected image in a superimposed manner when an (empty) photograph frame in the template video data 122 is displayed, using information of the photograph frame identifier 302, the display period of photograph frame 303, and the display position of photograph frame 304 in the template managing information 124.

FIG. 8 is a diagram showing an example of the thumbnail list display screen 600 in which the image displaying unit 118 displays an image in a superimposed manner on a video template according to Embodiment 1 of the present invention.

As shown in the diagram, the thumbnail image 601 indicates a thumbnail pointed by the cursor. Usually, when pointed by the cursor, the video thumbnail is automatically reproduced.

Moreover, the thumbnail images 602 and 603 are videos that use the same animated template as that in the thumbnail image 601 which is pointed by the cursor. Furthermore, the thumbnail image 604 indicates a video including an animated template different from that in the thumbnail image 601.

In the case shown in the diagram, since there exists the video that uses the same animated template as that in the video pointed by the cursor in the thumbnail list display screen 600, the image selected and obtained by the image obtaining unit 113 is displayed in a superimposed manner when an (empty) photograph frame of the animated template in the video is displayed.

Specifically, as for the thumbnail image 601, a template video data 122a is displayed in a display region in which the thumbnail image 601 is displayed, and an image data 123a is displayed in the region associated with the display region. Similarly, as for the thumbnail image 602, the template video data 122a and an image data 123b are displayed in a display region in which the thumbnail image 602 is displayed and in a region associated with the display region, respectively. Moreover, as for the thumbnail image 603, the template video data 122a and an image data 123c are displayed in a display region in which the thumbnail image 603 is displayed and in a region associated with the display region, respectively.

It is to be noted that the items of image data 123a, 123b, and 123c are displayed when the image display regions in the template video data 122a in the thumbnail images 601, 602, and 603 are displayed, respectively.

Moreover, although the items of image data 123a, 123b, and 123c are displayed in balloons as the regions associated with the display regions in which the thumbnail images 601, 602, and 603 are displayed. For example, provided that the spaces between the image data 123a, 123b, and 123c are sufficient, the items of image data 123a, 123b, and 123c may be displayed at predetermined positions between the video thumbnails adjacent to each other (for example, right side or left side of the target video thumbnail).

With this, the user can simultaneously compare and check animation effects of plural items of created video data 121 which use the same animated template, and images used therein.

Turning back to FIG. 6, when the reproduction of the video thumbnail reaches the end, the video thumbnail display device 100 stops the reproduction of the video thumbnail, or reproduces the video data from the beginning again (S116). Moreover, the user can freely stop the reproduction through an input operation during the reproduction of the video thumbnail.

Moreover, in the case where the template determining unit 112 determines that the created video data 121 that uses the same animated template as that in the video pointed by the cursor on the thumbnail list display screen does not exist (NO in S106), the video thumbnail display device 100 reproduces the created video data 121 as a video thumbnail as usual (S114).

It is to be noted that the created video data 121 is reproduced, for example, in such a way that the template video data 122 of the first template is decoded by the video decoding unit 114 and the decoded data is displayed by the video display unit 116.

Subsequently, when the reproduction of the video thumbnail reaches the end, the video thumbnail display device 100 stops the reproduction of the video thumbnail, or reproduces the video data from the beginning again (S116). Moreover, when the user moves the cursor to point another thumbnail image, the video thumbnail being reproduced stops reproducing and the thumbnail image is displayed again.

Described above is a flowchart of the operations of the video thumbnail display device 100, in displaying the video thumbnail, according to Embodiment 1 of the present invention.

Next, details of the processing of the image obtaining unit 113 for obtaining the first display image and the second display image (S108 in FIG. 6) will be described.

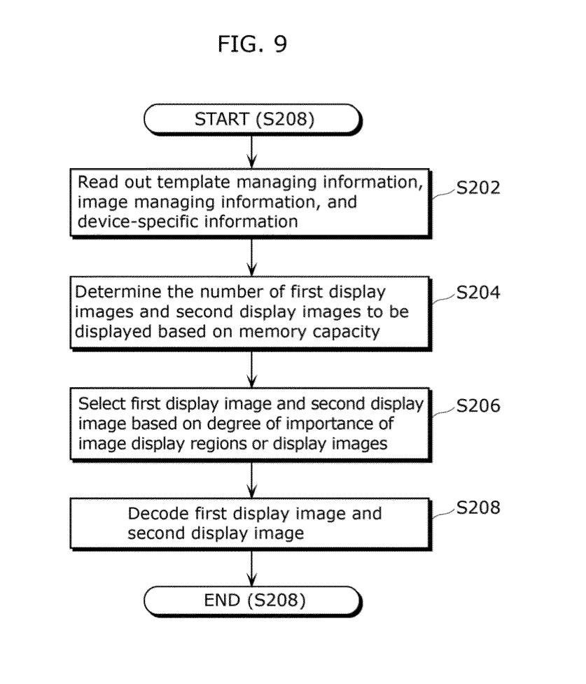

FIG. 9 is a flowchart showing an example of processing of the image obtaining unit 113 for obtaining the first display image and the second display image according to Embodiment 1 of the present invention.

First, as shown in the diagram, the image obtaining unit 113 reads out the template managing information 124, the image managing information 125, and the device-specific information 126 (S202).

Next, the image obtaining unit 113 determines the number of first display images and second display images based on an available memory capacity (S204). Specifically, the image obtaining unit 113, with reference to the super imposed image memory capacity 502 in the device-specific information 126, determines the numbers of first display images and second display images in such a manner that the number of display images is smaller as an available memory capacity is smaller.

Thus, in implementation of the video thumbnail display device 100 in the embedded device, it may be impossible to display all the images included in the created video data 121 as superimposed images. In the case where a large number of images are used in the animated template, decoding of the images one by one by the user by placing the cursor over the thumbnail images takes time, resulting in causing waiting time.

Here, a device having a large-capacity memory enables quick display by storing decoded data in the memory region before the thumbnail list display screen is activated. In fact, however, a limited memory capacity is available in many cases.

Thus, the superimposed image memory capacity 502 in the device-specific information 126 as shown in FIG. 5 is stored in advance. Accordingly, the number of photographs which can be prepared is determined according to the limited memory capacity and the determined number of photographs are superimposed.

Next, the image obtaining unit 113 selects the first display image and the second display image based on the degree of importance of the image display regions or of the display images (S206). That is, after the number of display images is determined, the image obtaining unit 113 selects the display images in descending order of importance of photograph frames to which photographs are linked, or importance of photographs.

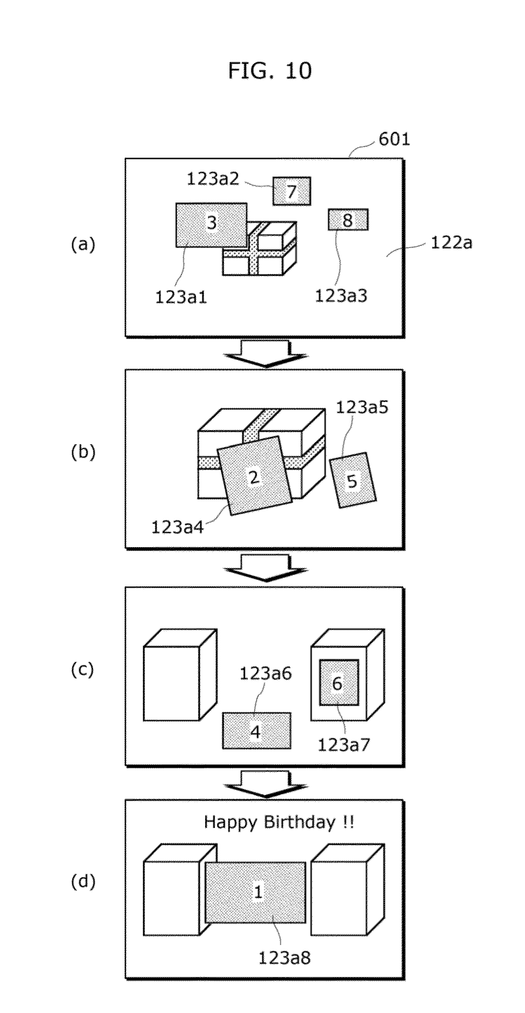

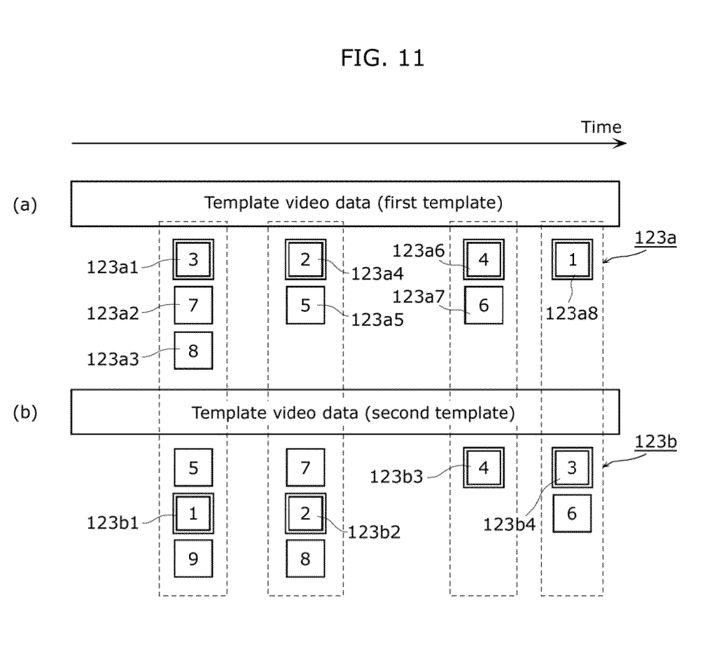

FIGS. 10 and 11 are diagrams illustrating that the image obtaining unit 113 according to Embodiment 1 of the present invention selects a display image based on the degree of importance of the image display regions or of the display images.

As shown in (a) to (d) in FIG. 10, as for the thumbnail image 601, the template video data 122a is reproduced, and during the reproduction of the template video data 122a, items of image data 123a1 to 123a8 that are the display images are displayed in the corresponding image display regions in each scene. Here, the numbers shown in the items of image data 123a1 to 123a8 in the diagram indicate the degree of importance of the image display regions or the degree of importance of the display images.

The image obtaining unit 113 selects display images in descending order of importance of the image display regions or importance of the display images from among the display images to be displayed in the image display region included in the video, to obtain the selected image as the first display image and the second display image.

Here, in selecting display images using the degree of importance of the image display region, the image obtaining unit 113 selects display images associated with image display regions in descending order of importance of the image display regions which is determined according to at least one of the display position, the size and the display period of each of the image display regions, to obtain the selected image as the first display image and the second display image. For example, the image display region in which the image data 123a8 in (d) in FIG. 10 is displayed is the image display region having the highest degree of importance.

For example, as shown in (a) in FIG. 11, the image obtaining unit 113 selects and obtains, as the first display image, the items of image data 123a1, 123a4, 123a6, and 123a8 which have the degree of importance 1, 2, 3, and 4, respectively. For example, as shown in (b) in FIG. 11, the image obtaining unit 113 selects and obtains, as the second display image, the items of image data 123b1 to 123b4 which have the degree of importance 1 to 4, respectively.

Accordingly, the image data 123a1 is displayed in (a) in FIG. 10, the image data 123a4 is displayed in (b) in FIG. 10, the image data 123a6 is displayed in (C) in FIG. 10, and the image data 123a8 is displayed in (d) in FIG. 10.

Turning back to FIG. 9, the image decoding unit 115 decodes the first display image and the second display image obtained by the image obtaining unit 113 (S208).

This is the end of the processing of the image obtaining unit 113 for obtaining the first display image and the second display image (S108 in FIG. 6).

As described above, the video thumbnail display device 100 according to Embodiment 1 of the present invention displays the first template in the first display region in which the first thumbnail is displayed and the first display image in the region associated with the first display region on the screen, while displaying the second template in the second display region in which the second thumbnail is displayed and the second display image in the region associated with the second display region on the screen. Here, the first template and the second template include the same video data. Accordingly, it is possible to decode the same video data using one video decoder, so that the first template and the second template can be decoded without deterioration in reproduction quality using a simple configuration. Moreover, the first display image and the second display image are displayed in the respective regions on the same screen, so that a desired video can be easily selected. With this, with the simple configuration, the desired video can be selected from a screen which displays plural video thumbnails that use the template including the same video data while suppressing deterioration in reproduction quality of the video thumbnails.

Moreover, each display image is displayed when the image display region is displayed in the video template. With this, the video templates and the display images can be matched in the video thumbnails, so that the desired video can be easily selected from the screen which displays the plural video thumbnails that use the templates including the same video data.

Moreover, the display images are selected in descending order of importance of the image display regions or importance of the display images. Accordingly, the display images are selected in order of importance of the image display regions or importance of the display images in the case where a number of display images exist, so that it is possible to reduce processing load in decoding the display images while suppressing deterioration in the reproduction quality of the video thumbnails.

Moreover, the display images are selected in descending order of importance of the image display regions which is determined according to at least one of the display position, the size and the display period of each of the image display regions. That is, since the degree of importance of the image display region can be determined according to at least one of the display position, the size and the display period of the image display region, the display image can be selected with an easy process.

Moreover, the display images are selected in such a manner that the number of display images is smaller as an available memory capacity is smaller. With this, the number of display images which need to be decoded is reduced in the case where the available memory capacity is small, thereby reducing processing load in decoding the display images.

Furthermore, the display image is obtained with reference to the template managing information 124 in which the video template and the identifier for the display image are associated, and the image managing information 125 in which the identifier and the information about the display image are associated. Accordingly, by using the template managing information 124 and the image managing information 125, the display image can be selected with an easy process.

### Variation of Embodiment 1

Next, a variation of Embodiment 1 will be described. In the above Embodiment 1, the image obtaining unit 113 determines the number of display images based on the available memory capacity and selects the display images in descending order of importance of the image display regions or the display images, to select the first display image and the second display image. However, in this variation, the image obtaining unit 113 selects display images which are decodable in display time intervals between display images to obtain the first display image and the second display image.

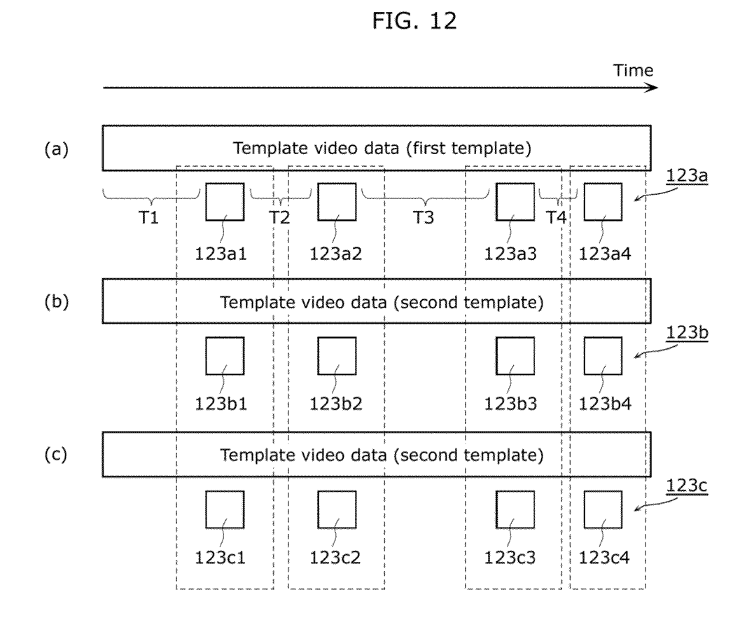

FIG. 12 is a diagram illustrating that the image obtaining unit 113 selects the display images decodable in display time intervals between the display images according to an variation of Embodiment 1 of the present invention.

The diagram illustrates the display order of the display images in the video thumbnails being executed, with a horizontal axis representing time. Specifically, (a) in FIG. 12 shows the display order of the image data 123a in the template video data of the first template, and (b) and (C) in FIG. 12 show the display order of the image data 123b and the image data 123c in the template video data of the second template. Moreover, time intervals T1 to T4 indicate time intervals between an image data item and another image data item in an animation.

Here, it is the best way of implementation, as in Embodiment 1, to decode 12 items of the image data 123a, 123b, and 123c and store them in advance in the storing unit 120 before the reproduction of the video thumbnail starts. However, as described in the above Embodiment 1, only 6 items of the image data may be stored depending on the memory capacity in the device.

In this case, only the image data having a high degree of importance that are the image data 123a1, the image data 123b1, the image data 123c1, the image data 123a3, the image data 123b3, and the image data 123c3 may be selected as photographs to be superimposed and stored in the memory region. This can avoid waiting time in implementation.

However, the image data 123a2, the image data 123b2, the image data 123c2, the image data 123a4, the image data 123b4, and the image data 123c4 may be desired to be selected as photographs to be superimposed because of a reason that, for example, they have a high degree of importance. In this case, the image decoding unit 115 decodes image data in the display time intervals between image data items, so that the image displaying unit 118 displays the image data.

Specifically, the image obtaining unit 113 determines, based on the image-decoding performance 501 (resolution and decoding processing time) in the device-specific information 126 as shown in FIG. 5 and the time intervals T1 to T4 between the image data items in the animation, whether or not a time interval is sufficient for decoding a corresponding image. In the case where the time interval is sufficient, the image can be decoded by the image decoding unit 115 and displayed by the image displaying unit 118 in a superimposed manner.

For example, in the case where the image obtaining unit 113 determines that the image data 123a4, the image data 123b4, and the image data 123c4 can be decoded in the time interval T3, the image decoding unit 115 decodes the image data 123a4, the image data 123b4, and the image data 123c4. With this, the present invention can be implemented even in the environment with limitations in resource such as a memory capacity.

As described above, according to the video thumbnail display device 100 in the variation of Embodiment 1 of the present invention, the image obtaining unit 113 selects display images that are decodable by the image decoding unit in the display time intervals between the display images included in a video represented by the thumbnail to obtain the first display image and the second display image.

Accordingly, decoding of the display image in the time interval allows a selection of more display images even in the case where only a limited memory capacity is available. Moreover, decoding only the display images decodable in the time interval can prevent deterioration in reproduction quality of the video thumbnail caused by a delay in decoding.

### Embodiment 2

Next, Embodiment 2 will be described. In the above Embodiment 1, the video thumbnail display device 100 includes the storing unit 120, and the controlling unit 110 causes the monitor 102 to display the list of the thumbnails using the information stored in the storing unit 120. However, in Embodiment 2, a video thumbnail display device 100 does not include a storing unit 120, and a controlling unit 110 causes a monitor 102 to display the list of the thumbnails using information obtained from an external device.

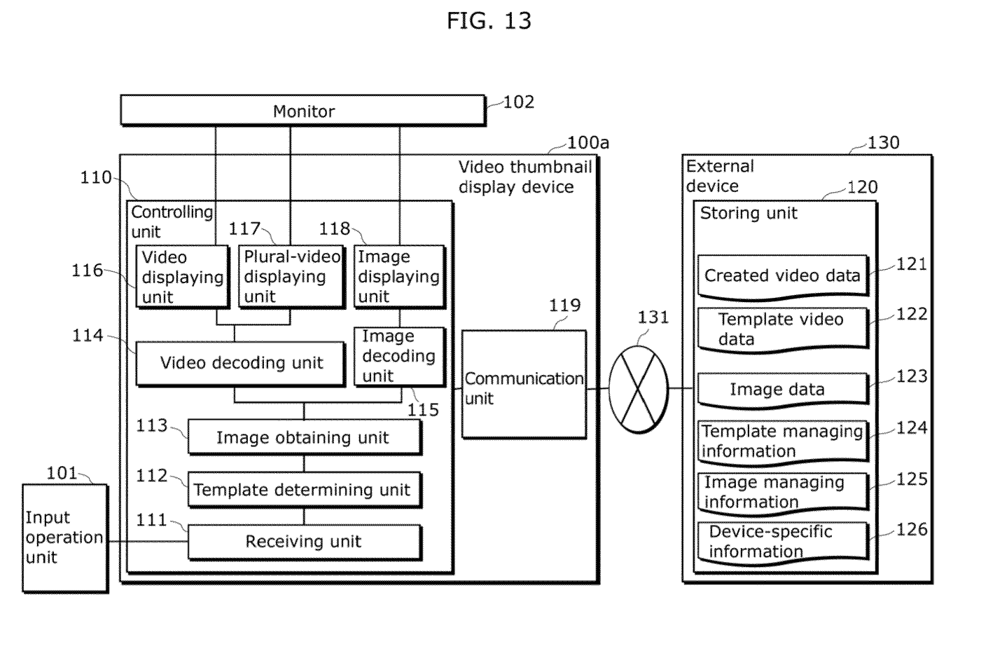

FIG. 13 is a block diagram showing a functional configuration of a video thumbnail display device 100a according to Embodiment 2 of the present invention.

As shown in the diagram, the video thumbnail display device 100a includes a communicating unit 119 instead of the storing unit 120 of the video thumbnail display device 100 in Embodiment 1 shown in FIG. 1. It is to be noted that since other constituent elements included in the video thumbnail display device 100a are the same as those of the video thumbnail display device 100 in Embodiment 1, detailed descriptions are omitted.

The communicating unit 119 is connected to an external device 130 via a communication network 131 and is capable of obtaining information from the external device 130. Here, the external device 130 includes the storing unit 120 of the video thumbnail display device 100 in Embodiment 1 shown in FIG. 1. It is to be noted that since the storing unit 120 included in the external device 130 is the same as the storing unit 120 in Embodiment 1, detailed descriptions are omitted.

The communicating unit 119 obtains template video data 122 included in a video template, image data 123 of a display image, template managing information 124, and image managing information 125 from the storing unit 120 in the external device 130 via the communication network 131.

Thus, the controlling unit 110 causes the monitor 102 to display the list of the thumbnails using the information obtained by the communicating unit 119 from the external device 130.

As described above, the video thumbnail display device 100a according to Embodiment 2 of the present invention obtains the template video data 122, the image data 123 of a display image, the template managing information 124, and the image managing information 125 via the communication network 131. Accordingly, the data and information can be obtained from the external device 130 even without the storing unit 120 in which the data and information is stored.

With this configuration, by using the video thumbnail display device according to the above embodiments and the variation, it is possible to simultaneously distinguish plural videos while comparing animation effects and photographs used therein.

Although the video thumbnail display device according to the embodiments and the variation of the present invention has been described above, the present invention is not limited to the embodiments and the variation.

It is to be understood that the disclosed embodiments and the variation is illustrative and not restrictive. The scope of the present invention is indicated not by the above description but by the claims, and is intended to include equivalents of the claims and all modifications within the scope of the claims.

For example, although the image is displayed in a superimposed manner on the video data in the above embodiments and the variation, any arrangement may be applicable as long as the association between the image and the video data can been seen, for example, the image and the video data may be displayed adjacent to each other.

Moreover, although the video thumbnail display device includes constituent elements shown in FIG. 1 or FIG. 13 in the embodiments and the variation, all the constituent elements shown in FIG. 1 or FIG. 13 need not necessarily be included.

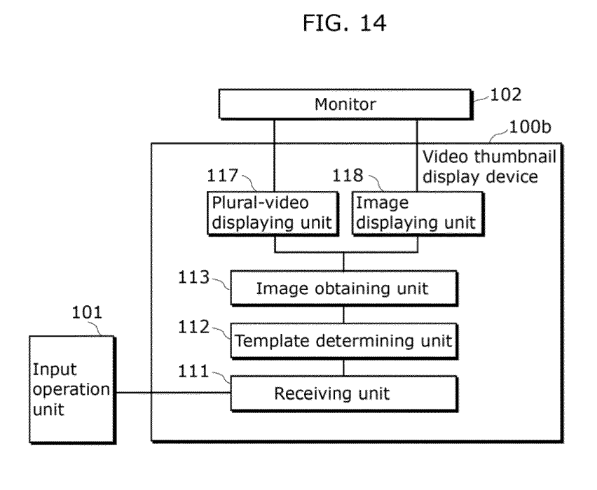

FIG. 14 is a block diagram showing a minimum configuration of the video thumbnail display device. As shown in the diagram, a video thumbnail display device 100b includes, as the minimum configuration, a receiving unit 111, a template determining unit 112, an image obtaining unit 113, and an image displaying unit 118.

Also with this configuration, the receiving unit 111 receives a selection of the first template, the template determining unit 112 determines whether or not the second thumbnail is displayed on the monitor 102, the image obtaining unit 113 obtains the first display image and the second display image, the plural-video displaying unit 117 displays the first template and the second template, the image displaying unit 118 displays the first display image and the second display image, so that the same effects as that of the above embodiments and the variation are achieved.

Moreover, a part or all of the constituent elements included in the video thumbnail display device according to the above embodiments and the variation may be in the form of a single System-Large-Scale Integration (LSI).

The System-LSI is a super-multi-function LSI manufactured by integrating constituent units on one chip, and is specifically a computer system configured by including a microprocessor, a Read Only Memory (ROM), a Random Access Memory (RAM), and the like. A computer program is stored in the ROM. The System-LSI achieves its function through the microprocessor's operation according to the computer program.

The name used here is System-LSI, but it may also be called IC, LSI, super LSI, or ultra LSI depending on the degree of integration. Moreover, ways to achieve integration are not limited to the LSI, and a special circuit or a general purpose processor can also achieve the integration. Field Programmable Gate Array (FPGA) that can be programmed after manufacturing LSI or a reconfigurable processor that allows re-configuration of circuit cells in the connection or configuration of LSI can be used.

Furthermore, if integrated circuit technology that replaces LSI appears thorough progress in semiconductor technology or other derived technology, that technology can naturally be used to carry out integration of the functional blocks. Application of biotechnology is one such possibility.

Moreover, the present invention can be implemented not only as the video thumbnail display device including such characteristic processing units but as the video thumbnail display method including, as steps, the characteristic processing units included in the video thumbnail display device. In addition, the present invention may be implemented as a computer program which causes a computer to perform the characteristic processing steps included in such a method. It goes without saying that such a computer program can be distributed via a non-transitory computer-readable recording medium such as a Compact Disc Read Only Memory (CD-ROM) or a communication network such as the Internet.

### INDUSTRIAL APPLICABILITY

Since the video thumbnail display device according to the present invention has one video decoder and is capable of simultaneously reproducing, as video thumbnails, video data items that use the same animated template, it is useful in embedded devices such as a TV, a HDD recorder, and a residential server.

### REFERENCE SIGNS LIST

100, 100a, 100b Video thumbnail display device
101 Input operation unit
102 Monitor
110 Controlling unit
111 Receiving unit
112 Template determining unit
113 Image obtaining unit
114 Video decoding unit
115 Image decoding unit
116 Video displaying unit
117 Plural-video displaying unit
118 Image displaying unit
119 Communicating unit
120 Storing unit
121 Created video data
122, 122a Template video data
123, 123a, 123b, 123c Image data
124 Template managing information
125 Image managing information
126 Device-specific information
130 External device
131 Communication network
200 Animated template display
201 Image display region
301 Animated template type
302 Photograph frame identifier
303 Display period of photograph frame
304 Display position of photograph frame
305 Degree of importance of photograph frame
306 Photograph identifier
401 Photograph identifier
402 File name
403 Resolution
404 Degree of importance of photograph
501 Image-decoding performance
502 Super imposed image memory capacity
600 Thumbnail list display screen
601, 602, 603, 604, 610 Thumbnail image
620 Supplemental information

1. A video thumbnail display device which displays, on a screen, a list of thumbnails representing videos, each of the videos including a video template that is a template including predetermined video data and a display image that is a still image displayed in an image display region in the video template, the device comprising:
a receiving unit configured to receive a selection of a first template that is a video template included in a video represented by a first thumbnail among the thumbnails displayed on the screen;
a template determining unit configured to determine whether or not a second thumbnail is displayed on the screen, the second thumbnail being a thumbnail representing a video including a second template which includes the same video data as that in the first template;
an image obtaining unit configured to obtain a first display image and a second display image in the case where the second thumbnail is determined to be displayed, the first display image being a display image included in the video represented by the first thumbnail, and the second display image being a display image included in the video represented by the second thumbnail;
a plural-video displaying unit configured to display the first template in a first display region on the screen in which the first thumbnail is displayed and to display the second template in a second display region on the screen in which the second thumbnail is displayed; and
an image displaying unit configured to display the first display image in a region associated with the first display region and to display the second display image in a region associated with the second display region.

2. The video thumbnail display device according to claim 1,
wherein the image displaying unit is configured to display the first display image when an image display region in the first template is displayed, and to display the second display image when an image display region in the second template is displayed.

3. The video thumbnail display device according to claim 1,
wherein the image obtaining unit is configured to select display images, from among display images to be displayed in image display regions included in the video, in descending order of importance of the image display regions or importance of the display images, to obtain the selected display images as the first display image and the second display image.

4. The video thumbnail display device according to claim 3,
wherein the image obtaining unit is configured to select display images that are associated with the image display regions in descending order of importance of the image display regions which is determined according to at least one of a display position, a size and a display period of each of the image display regions, to obtain the selected display images as the first display image and the second display image.

5. The video thumbnail display device according to claim 1,
wherein the image obtaining unit is configured to select display images in such a manner that the number of images is smaller as an available memory capacity is smaller, to obtain the selected display images as the first display image and the second display image.

6. The video thumbnail display device according to claim 1, further comprising
an image decoding unit configured to decode coded image data of the display image,
wherein the image displaying unit is configured to select display images that are decodable by the image decoding unit in display time intervals between display images included in one of the videos represented by the thumbnails, to obtain the selected display images as the first display image and the second display image.

7. The video thumbnail display device according to claim 1,
wherein the image obtaining unit is configured to obtain the first display image and the second display image with reference to template managing information and image managing information, the video template being associated with an identifier for identifying the display image to be displayed in the image display region in the video template in the template managing information, and the identifier being associated with information about the display image identified by the identifier in the image managing information.

8. The video thumbnail display device according to claim 7, further comprising
a communication unit configured to obtain video data included in the video template, image data of the display image, the template managing information, and the image managing information via a communication network.

9. The video thumbnail display device according to claim 1,
wherein the video template is a template including an animation,
the receiving unit is configured to receive a selection of the first template that uses the animation, and
the template determining unit is configured to determine whether or not the second thumbnail representing the video including the second template which includes the same animation as that in the first template is displayed.

10. A video thumbnail display method of displaying, on a screen, a list of thumbnails representing videos, each of the videos including a video template that is a template including predetermined video data and a display image that is a still image displayed in an image display region in the video template, the method comprising:
receiving a selection of a first template that is a video template included in a video represented by a first thumbnail among the thumbnails displayed on the screen;
determining whether or not a second thumbnail is displayed on the screen, the second thumbnail being a thumbnail representing a video including a second template which includes the same video data as that in the first template;
obtaining a first display image and a second display image in the case where the second thumbnail is determined to be displayed, the first display image being a display image included in the video represented by the first thumbnail and the second display image being a display image included in the video represented by the second thumbnail;
displaying the first template on the screen in a first display region in which the first thumbnail is displayed and displaying the second template in a second display region on the screen in which the second thumbnail is displayed; and
displaying the first display image in a region associated with the first display region and displaying the second display image in a region associated with the second display region.

11. A non-transitory computer-readable recording medium for use in a computer, the recording medium having a program recorded thereon for causing the computer to execute the video thumbnail display method according to claim 10.

12. An integrated circuit which displays, on a screen, a list of thumbnails representing videos, each of the videos including a video template that is a template including predetermined video data and a display image that is a still image displayed in an image display region in the video template, the integrated circuit comprising:
a receiving unit configured to receive a selection of a first template that is a video template included in a video represented by a first thumbnail among the thumbnails displayed on the screen;
a template determining unit configured to determine whether or not a second thumbnail is displayed, the second thumbnail being a thumbnail representing a video including a second template which includes the same video data as that in the first template;
an image obtaining unit configured to obtain a first display image and a second display image in the case where the second thumbnail is determined to be displayed, the first display image being a display image included in the video represented by the first thumbnail and the second display image being a display image included in the video represented by the second thumbnail;
a plural-video displaying unit configured to display the first template in a first display region on the screen in which the first thumbnail is displayed and to display the second template in a second display region on the screen in which the second thumbnail is displayed; and
an image displaying unit configured to display the first display image in a region associated with the first display region and to display the second display image in a region associated with the second display region.
